(19) United States
(12) Patent Application Publication
(10) Pub. No.: US 2024/0232163 A1
(43) Pub. Date: Jul. 11, 2024

(54) EFFICIENT DATA COLLECTION IN SECURITY INFORMATION AND EVENT MANAGEMENT SYSTEMS

(71) Applicant: INTERNATIONAL BUSINESS MACHINES CORPORATION, ARMONK, NY (US)

(72) Inventor: Recep Meric Degirmenci, Doha (QA)

(21) Appl. No.: 18/151,546

(22) Filed: Jan. 9, 2023

(51) Int. Cl. G06F 16/23; G06F 21/56

(52) U.S. Cl. CPC G06F 16/2358; G06F 21/562; G06F 21/566; G06F 2221/034

(57) ABSTRACT

A method, computer system, and computer program product for efficient data collection in security information and event management systems. The method generates a data model for a log type for collection of variable attributes, with the data model including nodes representing static content with each node having a set of variable values for which data are to be collected from log records. The method shares the data model with a remote collection component for collection of log data for an event of the log type so that the remote collection component traverses the data model to identify a matching node for the log data of an event and collects data of the variable attributes of the matching node. The method receives collected data from the remote collection component in the form of a node identifier and the collected data of the variable attributes of the matching node.

### BACKGROUND

The present invention relates to computer security, and more specifically, to security incident and event management solutions.

Security information and event management (SIEM) tools are responsible for collecting log data from several log sources across a network and running analytical methods on collected logs for correlation and event detection purposes. Due to the number of log sources in an enterprise network and the frequency of log generation, log collection traffic is bandwidth intensive.

With the expansion of a majority of a workload extending to multiple cloud providers and datacenters, SIEM solutions are adopting more and more distributed deployment models spanning to cloud datacenters. Considering the traffic load and real time communication requirements, bandwidth utilization for distributed SIEM deployments is very high. This bandwidth requirement comes with a high cost.

### SUMMARY

According to an embodiment of the present invention there is provided a computer-implemented method for efficient data collection in security information and event management systems, the method including: generating a data model for a log type for collection of variable attributes, where the data model includes nodes representing static content with each node having a set of variable values for which data are to be collected from log records; sharing the data model with a remote collection component for collection of log data for an event of the log type, where the remote collection component traverses the data model to identify a matching node for the log data of an event and collects data of the variable attributes of the matching node; and receiving collected data from the remote collection component in a form of a node identifier and the collected data of the variable attributes of the matching node.

According to another embodiment of the present invention there is provided a computer-implemented method for efficient data collection in security information and event management systems, the method carried out at a remote collection component, the method including: receiving a data model for a log type for collection of variable attributes from a central component, where the data model includes nodes representing static content with each node having a set of variable values for which data are to be collected; traversing the data model for a logged event to match log data to a matching node; collecting log data for the variable attributes of the matching node; and transmitting the collected log data in a form including a node identifier and the collected log data of the variable attributes of the matching node.

According to another embodiment of the present invention there is provided a system for efficient data collection in security information and event management systems, the system including: a processor and a memory configured to provide computer program instructions to the processor to execute the function of a central component including: a data model generating component for generating a data model for a log type for collection of variable attributes, where the data model includes nodes representing static content with each node having a set of variable values for which data are to be collected from log records; a sharing component for sharing the data model with a remote collection component for collection of log data for an event of the log type, where the remote collection component traverses the data model to identify a matching node for the log data of an event and collects data of the variable attributes of the matching node; and a collected data receiving component for receiving collected data from the remote collection component in the form of a node identifier and the collected data of the variable attributes of the matching node.

### BRIEF DESCRIPTION OF THE DRAWINGS

Embodiments of the present invention will now be described, by way of example only, with reference to the accompanying drawings:

FIG. 1 is a block diagram of an example embodiment of a distributed system in which the invention may be implemented accordance with embodiments of the present invention.

FIG. 2A is a flow diagram of a first example embodiment of a method in accordance with embodiments of the present invention.

FIG. 2B is a flow diagram of a second example embodiment of a method in accordance with embodiments of the present invention.

FIG. 3 is a schematic diagram of an example embodiment of a data model in accordance with embodiments of the present invention.

FIG. 4 is block diagram of an example embodiment of a system in accordance with embodiments of the present invention.

FIG. 5 is a block diagram of an example embodiment of a computing environment for the execution of at least some of the computer code involved in performing the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are provided for efficient data collection in security information and event management (SIEM) systems. The described approach generates a data model to represent types of event logs and provide a log reduction mechanism to increase the efficiency of data transfer from distributed log collection components to a central component of a SIEM system.

The described method and system efficiently collect data for multi-cloud SIEM systems by extracting valuable information from large log files and transferring only the valuable information from remote log collection components to a central component of the SIEM system to reduce network traffic load. This minimizes the amount of data being transferred from the log collection components to the central component.

The efficient data collection in SIEM systems is an improvement in the technical field of computer security generally and more particularly in the technical field of security information and events across distributed workloads.

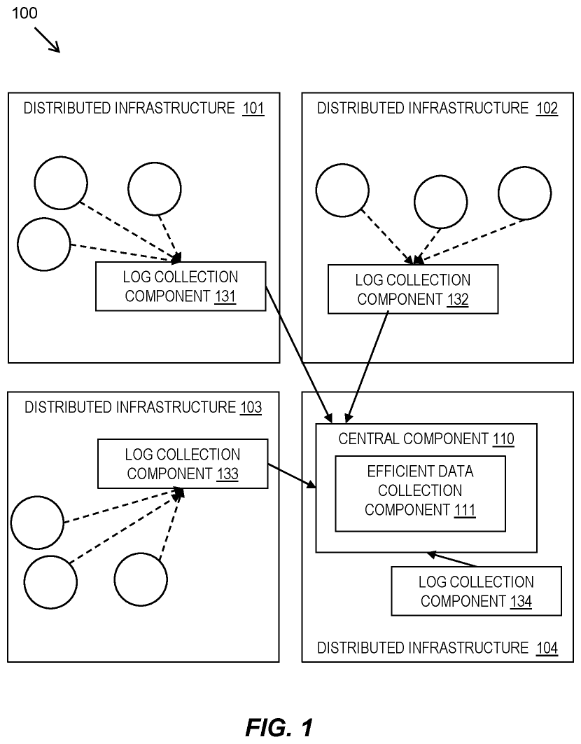

Referring to FIG. 1, a block diagram 100 shows a high level representation of an example embodiment of a SIEM system including a central component 110 of the SIEM system and multiple log collection components 131-134 that are distributed across multiple distributed infrastructures or environments 101-104 across a network. The distributed infrastructures 101-104 may be datacenters or cloud environments across which a workload may extend. There may be more than one central component 110 that are synced for high availability purposes.

The log collection components 131-134 collect log data from log sources across the network and transmit this data to the central component 110 that runs analytical methods on collected logs for correlation and event detection purposes.

In distributed deployments, the collection components 131-134 are responsible for collecting logs from their respective datacenter or cloud environment and sending to the central component 110. Due to the number of log sources in an enterprise network and the frequency of log generation, conventional log collection traffic is bandwidth intensive.

The described system includes an efficient data collection component 111 at the central component 110 for providing data models for log types used to extract required log event data from the log sources. The data models are applied at the log collection components 131-134 to reduce the amount of data that is sent to the central component 110.

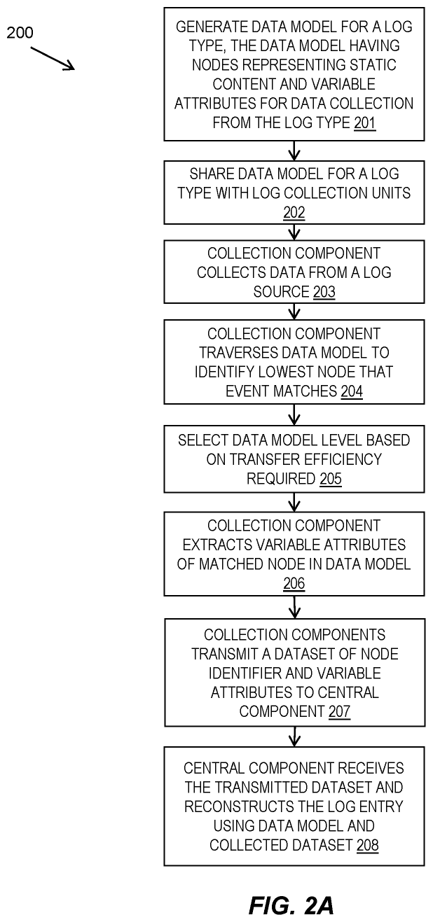

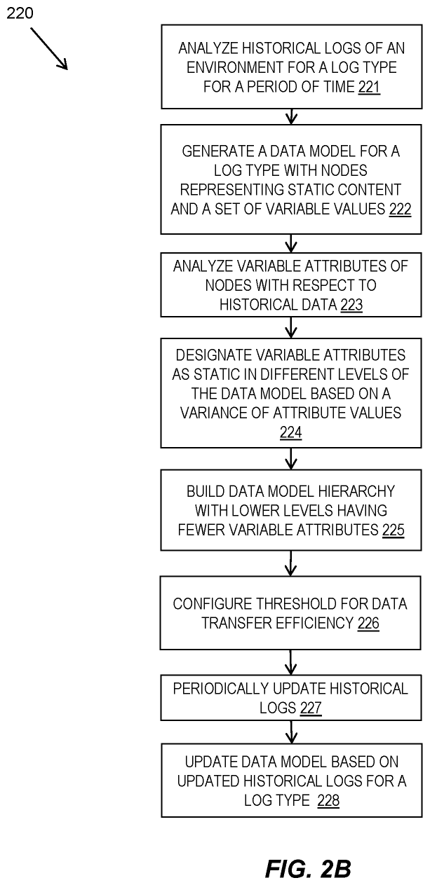

Referring to FIG. 2A, a flow diagram 200 shows an example embodiment of a method for efficient data collection in a SIEM system from distributed environments.

The method generates 201 a data model for a log type for collection of variable attributes. The data model includes nodes representing static content with each node having a set of variable values for which data are to be collected. A node may include a set of static attribute names for which variable attribute values are included in log data. A node may also include variable attributes that are treated as static values.

The data model may be a hierarchical data structure, such as a tree structure. The nodes of the lower levels of the hierarchical data structure include fewer variable attributes by treating some of the variable attributes in the log record as static, making the data transfer more efficient. Some variable attributes may be treated as static values due to them being very common or a finite set of variables in the environment and therefore not contributing useful log data. For example, a firewall action may be “accept” or “deny”. Treating these values as static means that these words are not transferred each time. Lower-level nodes have more variable values treated as static values thereby reducing the number of variable values in a node that are needed to be transferred.

The generation of a data model for a log type is described further with reference to FIG. 2B.

The method may share 202 the data model with remote log collection components at distributed infrastructures for collection of log data for events of the log type.

When an event is received at a remote log collection component, the collection component collects 203 data from a log source.

The remote log collection component traverses 204 the data model to find a branch of matching nodes for the collected logged event. The remote collection component may use a pre-order traversal algorithm to identify the lowest node matching the logged event.

The log collection component may select 205 a node level in the data model based on a predefined transfer efficiency as lower-level nodes in the data model contain fewer variable attributes to transfer.

The log collection component may extract 206 the variable attributes for a matched node of the selected level in the data model from the event data log and may compile a dataset including a node identifier and the extracted variable attributes resulting in a reduced dataset for transmission.

The log collection components may transmit 207 the compiled dataset of node identifier and the variable attributes of the designated matched node to a central component.

The central component may receive 208 the dataset of the collected data from the remote collection component and may reconstruct the log entry using the data model and the transmitted dataset.

The central component may store the collected data as received from the remote collection components or as reconstructed as a log entry as required for analysis of the captured event.

Referring to FIG. 2B, a flow diagram 220 shows an example embodiment of a method for generation of a data model for use in the efficient data collection in SIEM systems.

The method may analyze 221 historical logs of an environment for a log type for a sufficient period of time.

The method may generate 222 a data model for a log type including nodes representing static content with each node having a set of variable values.

The method may analyze 223 the variable data of the historical logs to determine the variance of the variable attributes of a log record. The method may designate 224 variable attributes as static in different levels of a hierarchical data model based on a variance of the attribute values determined from historical logs. The method may build 225 a data model with a hierarchy of nodes representing static content with lower levels of the hierarchy including fewer variable attributes.

At higher levels of the data model, attributes with low variance are represented as static context with remaining attributes represented as variable values. Moving to the lower levels of the data model, the attributes with higher variance are represented as static context until the predefined efficiency threshold is met.

The method may configure 226 a threshold of data transfer efficiency and set a minimum percentage of sample set representation where an attribute is represented as a static value.

The method may periodically update or replace 227 historical logs with newly collected log data as reconstructed from the received extracted datasets. The data model may be updated to a new iteration 228 based on the updated historical logs for a log type.

The generation of the data model including analysis of the historical logs may be carried out at the central component of a SIEM system.

In an example embodiment, event logs from different sources may be generated in the following format:
<Vendor Text>
<attribute Name 1 ><attribute Value 1>
<attribute Name 2 ><attribute Value 2>
<attribute Name 3 ><attribute Value 3>
<attribute Name 4 ><attribute Value 4>

“Vendor Text” and “Attribute Name” are static fields that do not change in different events from the same log source. Some “Attribute Values” are predefined and have a finite set of variables. Furthermore, some organization dependent “Attribute Values” are highly static.

The aim of the described method is to minimize the amount of data being transferred from log collection components to a central component without compromising the valuable information. This focuses on static fields and data that does not vary or does not vary significantly between log records of a log type.

When the log records from collection infrastructures are analyzed, it becomes clear that only some of the data represents valuable information and the rest of the data is duplicated between records. The method extracts the valuable information from large log files and transfers only the valuable information to reduce network traffic load.

### Example 1: Successful Authentication Log

A “Successful Authentication Log” is shown below with the variable data shown in bold. The rest of the data are static fields.

An account was successfully logged on. The log given below is a typical Microsoft Windows log entry (Microsoft and Windows are trademarks of Microsoft Corporation).

### Subject:

Security ID: SYSTEM
Account Name: DESKTOP-LLHJ389$
Account Domain: WORKGROUP
Logon ID: 0x3E7

### Logon Information:

Logon Type: 7
Restricted Admin Mode:
Virtual Account: No
Elevated Token: No

### Impersonation Level: Impersonation

### New Logon:

Security ID: AzureAD\FredSmith
Account Name: fsmith@company.com
Account Domain: AzureAD
Logon ID: 0xFD5112A
Network Account Name:
Network Account Domain:
Logon GUID: {0000000-0000-0000-0000-00000000}

### Process Information:

Process ID: 0x30c
Process Name: C:\Windows\System32\lsass.exe

### Network Information:

Workstation Name: DESKTOP-LLHJ389
Source Network Address:
Source Port:

### Detailed Authentication Information:

Logon Process: Negotiate
Authentication Package: Negotiate
Transited Services:
Package Name (NTLM only):
Key Length: 0

### Example 2: Checkpoint Firewall Log

A “Checkpoint Firewall Log” is shown below with the variable data shown in bold. The rest of the data are static fields.

“loc=2302|filename=fw.log|field=1506445139|time=26Sep201720:18:31|action=accept|orig=10.10.10.254|orig_name=firewall∥i/f_dir=inbound|has_accounting=0|product=FG|src=10.10.10.131|s_port=50039|dst=195.244.32.152|service=80|service_name=http|proto=tcp|_policy_id_tag=product=VPN-1 & Firewall[db_tag={6CACC116-CA9B-0C40-8058-68405ABF999A};mgmt=firewall;date=1503862935;policy_name=defaultfilter]|origin_sic_name=cn=cp_mgmt,o=firewall.sdfdsfasd.itv9jz”,“id”:“44eb1002a34f11e797330050568269ea”,“time”:1506516252,“hash”:“5374aa13”

In the described approach, each different log type is represented in a data model such as a tree structure with each node representing a static context and a set of variable values. The tree structure is generated by assessing historical logs of an environment for a sufficient period of time.

In the higher levels of a tree structure, attributes with low variance may be represented as static context with remaining attributes represented as variable values. Progressing to the lower levels of the tree, the attributes with gradually higher variance may be represented as static context until a predefined efficiency threshold is reached.

Below is a representation of an illustrated log source:

### <Event Log>

Domain: NAME
Destination Address: 10.10.1.32
Timestamp: 26Sep2017 20:18:31
Logon Type: 3
   <Vendor provided information>

The attributes may be evaluated as follows:

For the “Domain” attribute, across the environment there may be 3 different values observed for “Domain”, NAME1, NAME2, NAME3. As the variance is low this is a candidate variable to be represented as a static context.

For the “Destination Address” attribute, across the environment, there may be +100 unique IP addressed observed under “Destination Address”. This is not a candidate variable to be represented as static context.

The “Timestamp” is a near unique value which is not suitable to be represented as a static context.

For the “Logon Type” attribute, across the environment there are 3 different values observed 3, 5 and 2. Therefore, the “Logon Type” is a candidate variable to be represented as a static context.

Considering the scenario above, “Logon Type” and “Domain” attributes are the candidates to be represented as static values in the nodes of the tree.

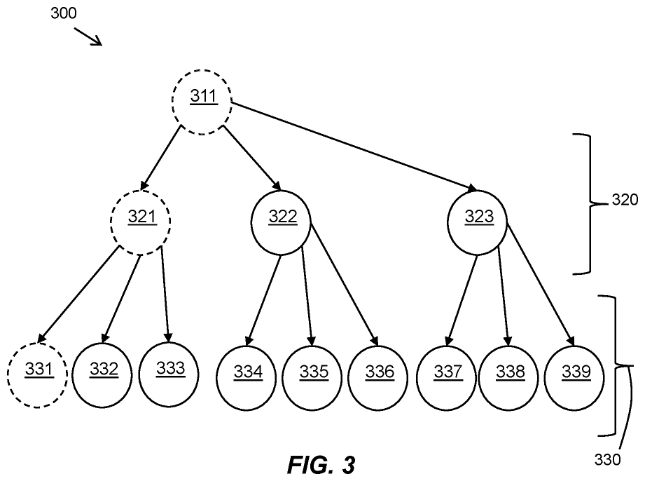

FIG. 3 shows an example tree structure 300 for this example. A root node 311 is provided. A first level 320 is for the “Logon Type” with the 3 options provided as static context in nodes 321, 322, 323. A second level 330 is for the “Domain” with 3 options provided as static context in nodes 331-339.

Node 311 is the root node with all attributes being variables (shown in bold):

### <Event Log>

Domain: <Attribute 1>
Destination Address: <Attribute 2>
Timestamp: <Attribute 3>
Logon Type: <Attribute 4>
   <Vendor provided information>

Node 321 is the node in the first level 320 with the attribute “Logon Type” “3” being static and the other attributes being variable:

### <Event Log>

Domain: <Attribute 1>
Destination Address: <Attribute 2>
Timestamp: <Attribute 3>
Logon Type: 3
   <Vendor provided information>

Node 331 is the node in the second level 330 with the attribute “Logon Type” “3” and the attribute “Domain” “NAME1” being static and the other attributes being variable:

### <Event Log>

Domain: NAME1
Destination Address: <Attribute 2>
Timestamp: <Attribute 3>
Logon Type: 3
   <Vendor provided information>

Node 332 is the node in the second level 330 with the attribute “Logon Type” “3” and the attribute “Domain” “NAME2” being static and the other attributes being variable:

### <Event Log>

Domain: NAME2
Destination Address: <Attribute 2>
Timestamp: <Attribute 3>
Logon Type: 3
   <Vendor provided information>

Node 333 is the node in the second level 330 with the attribute “Logon Type” “3” and the attribute “Domain” “NAME3” being static and the other attributes being variable:

### <Event Log>

Domain: NAME3
Destination Address: <Attribute 2>
Timestamp: <Attribute 3>
Logon Type: 3
   <Vendor provided information>

In below sample, the efficiency threshold is set to 10%. Efficiency Threshold is a term to set the minimum percentage of sample set representation where an attribute is represented as a static value.

A collection component may traverse the tree structure 300 and may identify the branch of nodes 311, 321 and 331 (shown as dashed nodes) as matching collected log data for a logged event of the type represented by the tree structure 300.

Node 331 is selected as the node that meets the defined efficiency threshold and the matching log entry is as follows:

### <Event Log>

Domain: NAME1
Destination Address: <10.10.1.32>
Timestamp: <26Sep2022 20:18:31>
Logon Type: 3
   <Vendor provided information>

The data that is transferred from the log collection component to the central component is therefore: <node331><10.10.1.32><26Sep2022 20:18:31>. This is a very efficient form of data transfer for the logged event.

The central component may reconstruct the log record by identifying that node 331 has known static values and inserting the variable attribute values into the log record.

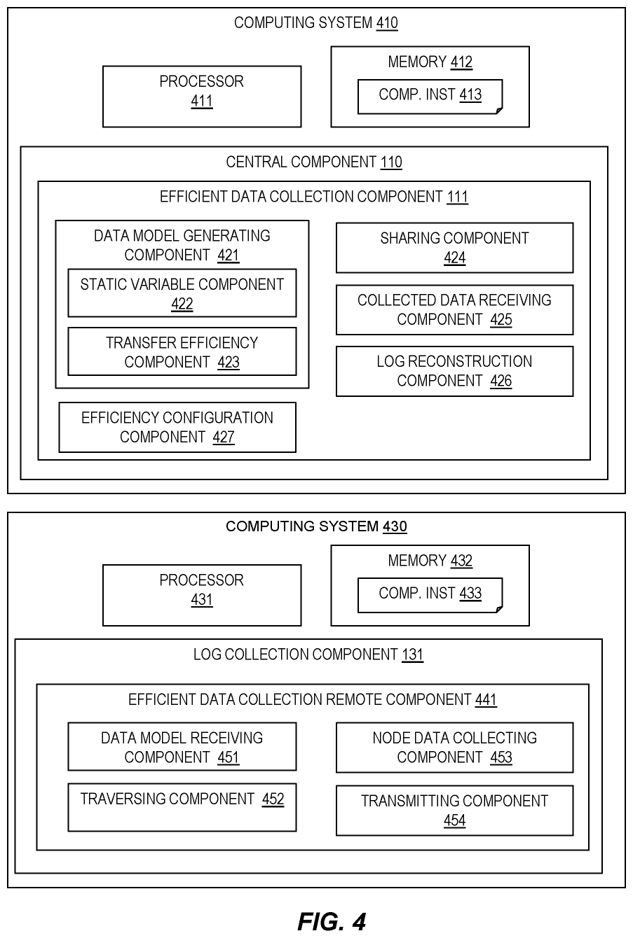

Referring to FIG. 4, a block diagram shows the structural components of the efficient data collection component 111 at the central component 110 and an efficient data collection remote component 441 at a log collection component 131. The central component 110 and the log collection component 131 may each run on a computing system 410, 430 in a distributed infrastructure 104, 101. The computing systems 410, 430 may include at least one processor 411, 431, respectively, a hardware module, or a circuit for executing the functions of the described components which may be software units executing on the at least one processor. Multiple processors running parallel processing threads may be provided enabling parallel processing of some or all of the functions of the components. Memory 412, 432 may be configured to provide computer instructions 413, 433, respectively, to the at least one processor 411, 431 to carry out the functionality of the components.

The efficient data collection component 111 at the central component 110 may include a data model generating component 421 for generating a data model for a log type for collection of variable attributes. The data model includes nodes representing static content with each node having a set of variable values for which data are to be collected from log records.

The data model generating component 421 may build a hierarchy of nodes with each node representing a set of static content of a log record with nodes at lower levels of the hierarchy including fewer variable attributes.

The data model generating component 421 may include a static variable component 422 for designating variable attributes as static based on a variance of the attribute values. The static variable component 422 may analyzes the variance of attributes from historic log data as updated periodically with collected log data.

The data model generating component 421 may include a transfer efficiency component 423 for providing levels of the data model as thresholds of data transfer efficiency and setting a minimum percentage of sample set representation where an attribute is represented as a static value.

The efficient data collection component 111 at the central component 110 may include a sharing component 424 for sharing the data model with a remote log collection component 131 for collection of log data for an event of the log type.

The efficient data collection component 111 at the central component 110 may include an efficiency configuration component 427 for configuring a required data transfer efficiency as a threshold percentage of a sample set representation where an attribute is represented as a static value.

The efficient data collection component 111 at the central component 110 may include a collected data receiving component 425 for receiving collected data from the remote collection component in the form of an identifier of a node and the collected data of the variable attributes of the node.

The efficient data collection component 111 at the central component 110 may include a log reconstruction component 426 for using the data model to reconstruct a log record from the node identifier and the collected data of the variable attributes of the node.

The efficient data collection remote component 441 at the log collection component 131 may include a data model receiving component 451 for receiving a data model from the central component for collection of log data for an event of the log type.

The efficient data collection remote component 441 at the log collection component 131 may include a traversing component 452 for traversing the data model to select a matching node for the log data of an event. The traversing component 452 may match the log data to a matching node at a level of the data model for a defined transfer efficiency.

The efficient data collection remote component 441 at the log collection component 131 may include a node data collecting component 453 for collecting log data for the variable attributes of the matching node.

The efficient data collection remote component 441 at the log collection component 131 may include a transmitting component 454 for transmitting the collected data in including a node identifier and the collected data of the variable attributes of the matching node.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include:

diskette, hard disk, random access memory (RAM), read-only memory (ROM), erasable programmable read-only memory (EPROM or Flash memory), static random access memory

(SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

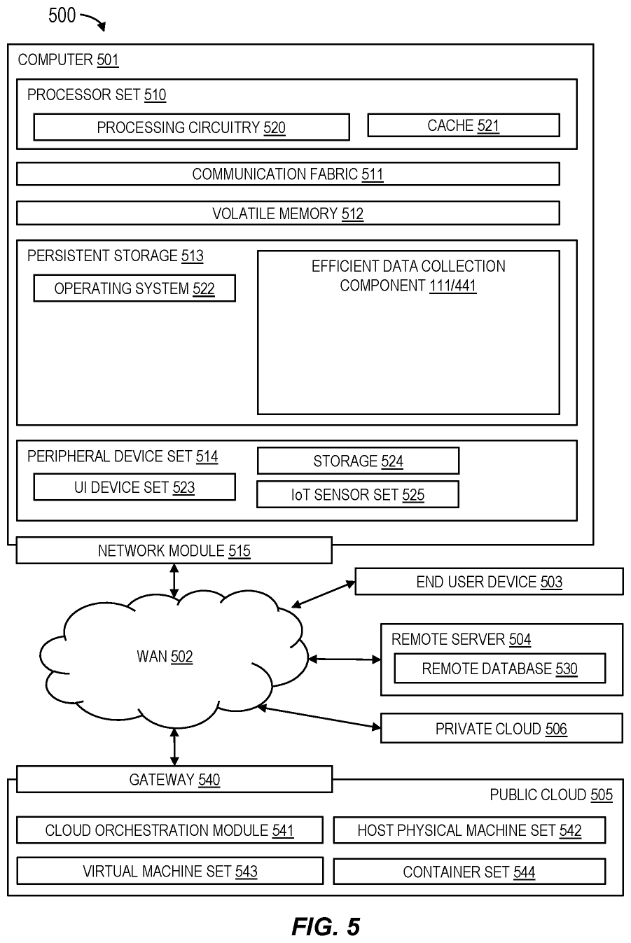

Referring to FIG. 5, computing environment 500 contains an example of an environment for the execution of at least some of the computer code involved in performing the inventive methods, such as the efficient data collection component 111 of the central component 110 and the efficient data collection remote components 441 of the log collection components 131. In addition to block 111/441, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 111/441, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, central frame computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 111/441 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 111/441 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

According to another embodiment of the present invention there may be provided a system for efficient data collection in security information and event management systems, comprising: a processor and a memory configured to provide computer program instructions to the processor to execute the function of a log collection component including: a data model receiving component for receiving a data model from the central component for collection of log data for an event of the log type, where the data model includes nodes representing static content with each node having a set of variable values for which data are to be collected; a traversing component for traversing the data model to select a matching node for the log data of an event; a node data collecting component for collecting log data for the variable attributes of the matching node; and a transmitting component for transmitting the collected data in including a node identifier and the collected data of the variable attributes of the matching node.

According to another embodiment of the present invention there may be provided a computer program product for efficient data collection in security information and event management systems at a central component, the computer program product comprising a computer readable storage medium having program instructions embodied therewith, the program instructions executable by a processor to cause the processor to: generate a data model for a log type for collection of variable attributes, where the data model includes nodes representing static content with each node having a set of variable values for which data are to be collected from log records; share the data model with a remote collection component for collection of log data for an event of the log type, where the remote collection component traverses the data model to identify a matching node for the log data of an event and collects data of the variable attributes of the matching node; and receive collected data from the remote collection component in the form of a node identifier and the collected data of the variable attributes of the node.

According to another embodiment of the present invention there may be provided a computer program product for efficient data collection in security information and event management systems at a central component, the computer program product comprising a computer readable storage medium having program instructions embodied therewith, the program instructions executable by a processor to cause the processor to: receive a data model for a log type for collection of variable attributes from a central component, where the data model includes nodes representing static content with each node having a set of variable values for which data are to be collected; traverse the data model for a logged event to match the log data to a matching node; collect log data for the variable attributes of the matching node; and transmit the collected data in including a node identifier and the collected data of the variable attributes of the matching node.

The computer readable storage medium may be a non-transitory computer readable storage medium, and the computer readable program code may be executable by a processing circuit.

What is claimed is:

1. A computer-implemented method for efficient data collection in security information and event management systems, the method comprising:
generating a data model for a log type for collection of variable attributes, wherein the data model includes nodes representing static content with each node having a set of variable values for which data are to be collected from log records;
sharing the data model with a remote collection component for collection of log data for an event of the log type, wherein the remote collection component traverses the data model to identify a matching node for the log data of an event and collects data of variable attributes of the matching node; and
receiving collected data from the remote collection component in a form of a node identifier and the collected data of the variable attributes of the matching node.

2. The method of claim 1, wherein generating a data model includes building a hierarchy of nodes with each node representing a set of static content of a log record with nodes at lower levels of the hierarchy including fewer variable attributes.

3. The method of claim 1, wherein generating a data model includes designating variable attributes as static based on a variance of attribute values.

4. The method of claim 3, wherein the variance of attribute values is analyzed from historic log data and updated periodically with collected log data.

5. The method of claim 1, wherein generating a data model includes providing levels of the data model as thresholds of data transfer efficiency based on a proportion of attributes represented as static values in a node.

6. The method of claim 1, including configuring a required data transfer efficiency as a threshold percentage of a sample set representation where an attribute is represented as a static value.

7. The method of claim 1, including using the data model to reconstruct a log record from the node identifier and the collected data of the variable attributes of the matching node.

8. A computer-implemented method for efficient data collection in security information and event management systems, the method carried out at a remote collection component, the method comprising:
receiving a data model for a log type for collection of variable attributes from a central component, wherein the data model includes nodes representing static content with each node having a set of variable values for which data are to be collected;
traversing the data model for a logged event to match log data to a matching node;
collecting the log data for variable attributes of the matching node; and
transmitting the collected log data in a form including a node identifier and the collected log data of the variable attributes of the matching node.

9. The method of claim 8, wherein matching the log data to the matching node includes matching to a node at a level of the data model for a defined transfer efficiency.

10. A system for efficient data collection in security information and event management systems, the system comprising:
a processor and a memory configured to provide computer program instructions to the processor to execute a function of a central component including:
a data model generating component for generating a data model for a log type for collection of variable attributes, wherein the data model includes nodes representing static content with each node having a set of variable values for which data are to be collected from log records;
a sharing component for sharing the data model with a remote collection component for collection of log data for an event of the log type, wherein the remote collection component traverses the data model to identify a matching node for the log data of an event and collects data of variable attributes of the matching node; and
a collected data receiving component for receiving collected data from the remote collection component in a form of a node identifier and the collected data of the variable attributes of the matching node.

11. The system of claim 10, wherein the data model generating component builds a hierarchy of nodes with each node representing a set of static content of a log record with nodes at lower levels of the hierarchy including fewer variable attributes.

12. The system of claim 10, wherein the data model generating component includes a static variable component for designating variable attributes as static based on a variance of attribute values.

13. The system of claim 12, wherein the static variable component analyzes the variance of attribute values from historic log data as updated periodically with collected log data.

14. The system of claim 10, wherein the data model generating component includes a transfer efficiency component for providing levels of the data model as thresholds of data transfer efficiency based on a proportion of attributes represented as static values in a node.

15. The system of claim 10, further comprising:
an efficiency configuration component for configuring a required data transfer efficiency as a threshold percentage of a sample set representation where an attribute is represented as a static value.

16. The system of claim 10, further comprising:
a log reconstruction component for using the data model to reconstruct a log record from the node identifier and the collected data of the variable attributes of the matching node.

17. The system of claim 10, wherein the processor and the memory are further configured to provide computer program instructions to the processor to execute a function of a log collection component including:
a data model receiving component for receiving a data model from the central component for collection of log data for an event of the log type; and
a traversing component for traversing the data model to select a matching node for the log data of an event.

18. The system of claim 17, wherein the traversing component matches the log data to a matching node at a level of the data model for a defined transfer efficiency.

19. The system of claim 17, further comprising:
a node data collecting component for collecting log data for the variable attributes of the matching node.

20. The system of claim 17, further comprising:
a transmitting component for transmitting the collected log data in a form including a node identifier and the collected log data of the variable attributes of the matching node.
